(19) United States
(12) Patent Application Publication
(10) Pub. No.: US 2018/0157502 A1
(43) Pub. Date: Jun. 7, 2018

(54) METHOD FOR MANAGING CHANGED FINANCIAL DATA AND COMPUTER PROGRAM PRODUCT

(71) Applicant: CyberSoft Digital Services Corp., Taipei City (TW)

(72) Inventors: CHUN-KANG CHU, Taipei City (TW); SZU-CHIEH SUNG, Taipei City (TW)

(21) Appl. No.: 15/441,830

(22) Filed: Feb. 24, 2017

(30) Foreign Application Priority Data
Dec. 6, 2016 (CN) 201611112696.2

(51) Int. Cl. G06F 9/44; G06Q 40/00; G06T 11/00; G06F 17/24

(52) U.S. Cl. CPC G06F 9/4446; G06F 17/243; G06T 11/001; G06Q 40/00

(57) ABSTRACT

A method for managing changed financial data includes reading a financial data from a storage unit and providing a financial screen according to the financial data. The financial data includes established contents of a plurality of items and a changed content of one or more items, and the financial screen includes fields of the items. The providing step includes: representing each changed content in the corresponding field, representing the established contents of the remaining items in the corresponding fields, and setting a color mark for the field that represents the changed content.

### CROSS-REFERENCE TO RELATED APPLICATION

This non-provisional application claims priority under 35 U.S.C. §119(a) to Patent Application No. 201611112696.2 filed in China, P.R.C. on Dec. 6, 2016, the entire contents of which are hereby incorporated by reference.

### BACKGROUND

### Technical Field

The present invention relates to a technology for managing financial data, and in particular, to a method for managing changed financial data.

### Related Art

With the development of Internet technologies, a service mode of Internet banking or online banking begins to appear in financial institutions. The Internet banking or online banking means that financial institutions, such as commercial banks, provide various financial services, such as account inquiry, transfers, and online transactions, for their users by using the Internet. As long as a user of the internet banking or online banking has one Internet-enabled computer, the user can use a browser or proprietary client software to use the various financial services provided by the financial institutions. As compared with conventional service modes (such as a physical counter and manual management), for users, the internet banking or online banking has the advantages of convenience and rapidity, and for financial institutions, the internet banking or online banking may also enable them to save a lot of labor costs.

To provide various financial services by using the Internet, the financial institutions must perform electronic management on financial data of each user. When the financial data has a content change, every changed content needs to be reviewed at multiple checkpoints such as examination and clearance, and after passing the reviews at all of the checkpoints, the changed content can be received, and a financial service system provides a relevant financial service for the user on the basis of the changed content. However, each financial data has contents of decades of items or more, but sometimes, an applicant may only change contents of several items among the decades of items. Therefore, when reviewing the whole window, a checkpoint reviewer must spend a lot of time to check which financial data has a changed content, thereby affecting providing of a financial service.

### SUMMARY

In an embodiment, a method for managing changed financial data includes: reading a financial data from a storage unit and providing a financial screen according to an established content and a changed content in the financial data. Herein, the financial data includes established contents of a plurality of items and a changed content of at least one of the items, and the financial screen includes fields of the items.

The providing step includes: representing each changed content in the corresponding field, representing each of the established contents of remaining ones of the items in the corresponding field, and setting a color mark for the field that represents each of the changed contents.

In an embodiment, a method for managing changed financial data includes: providing a financial screen according to a financial data to perform editing, receiving the edited financial screen, comparing each input content with a corresponding established content according to an acknowledgment signal, when the input content is different from the corresponding established content, setting the input content as a changed content of the item into the financial data, and when the input content is different from the corresponding established content, not setting the input content as the changed content of the item into the financial data. The financial data includes established contents of a plurality of items. The financial screen includes fields of the items, and each of the established contents is represented in the corresponding field. The established content represented by at least one of the fields in the edited financial screen is changed to an input content.

In an embodiment, a method for managing changed financial data includes: providing a list screen according to at least one financial data and setting a color mark for a data area that represents each first financial data on the list screen. The list screen includes at least one data area, and the at least one data area separately represents an excerpted content of the at least one financial data. The at least one financial data includes at least one first financial data, and each the first financial data includes at least one changed content.

In an embodiment, a computer program product includes a plurality of program codes, where the foregoing methods for managing changed financial data can be implemented after a computer loads and executes the plurality of program codes.

In conclusion, a method for managing changed financial data and a computer program product according to the present invention are applicable to providing a financial data-related screen for a user to view and/or review and setting a color mark for a corresponding content of financial data having a changed content, so that the corresponding content of the financial data having the changed content on the screen is apparently displayed, so as to enable the user to rapidly view the changed content and even make a review, thereby accelerating the review on the financial data.

### BRIEF DESCRIPTION OF THE DRAWINGS

The present invention will become more fully understood from the detailed description given herein below for illustration only, and thus are not limitative of the present invention, and wherein:

FIG. 1 is a functional block diagram of a server according to an embodiment of the present invention;

FIG. 2 is a schematic diagram of a service architecture of a server according to an embodiment of the present invention;

FIG. 3 is a flowchart of a method for managing changed financial data according to a first embodiment of the present invention;

FIG. 4 is a schematic diagram of a financial screen according to a first example;

FIG. 5 is a flowchart of a method for managing changed financial data according to a second embodiment of the present invention;

FIG. 6 is a partial schematic diagram of a financial screen according to a second example;

FIG. 7 is a partial schematic diagram of a financial screen according to a third example;

FIG. 8 is a flowchart of a method for managing changed financial data according to a third embodiment of the present invention;

FIG. 9 is a partial schematic diagram of a financial screen according to a fourth example;

FIG. 10 is a flowchart of a method for managing changed financial data according to a fourth embodiment of the present invention;

FIG. 11 is a flowchart of a method for managing changed financial data according to a fifth embodiment of the present invention;

FIG. 12 is a schematic diagram of a list screen according to the first example; and

FIG. 13 is a schematic diagram of a list screen according to the second example.

### DETAILED DESCRIPTION

In some embodiments, a method for managing changed financial data according to the present invention may be implemented by a computer program product. The computer program product includes a plurality of program codes, so that the method for managing changed financial data according to any embodiment of the present invention can be implemented after a computer (namely, a server) loads and executes the program codes. In some embodiments, the computer program product may be a readable recording medium, and the foregoing program is stored in the readable recording medium for a computer to load. In some embodiments, the foregoing program may be a computer program product and is transmitted to a computer in a wired or wireless manner.

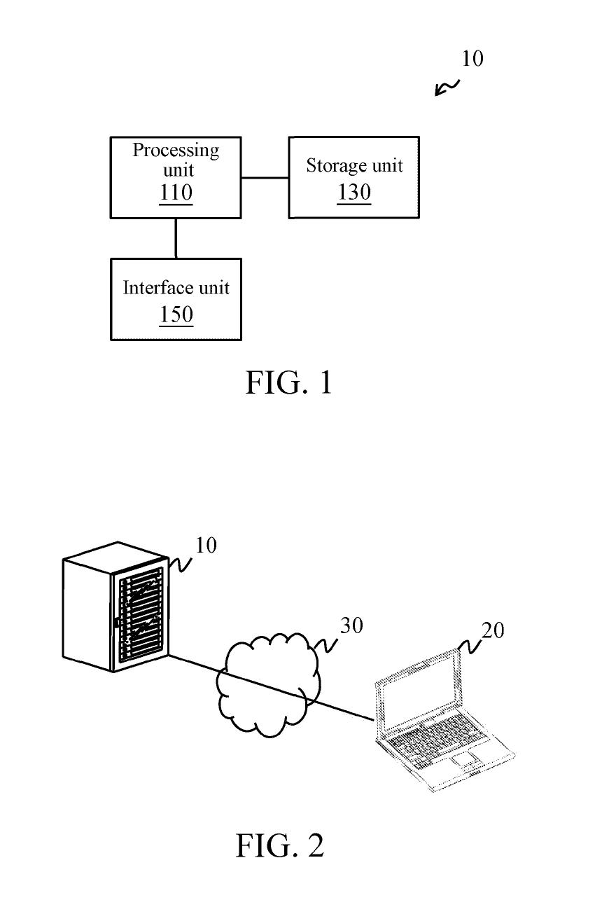

FIG. 1 is a functional block diagram of a server according to an embodiment of the present invention. FIG. 2 is a schematic diagram of a service architecture of a server according to an embodiment of the present invention.

Referring to FIG. 1, a method for managing changed financial data according to any embodiment of the present invention is applicable to a server 10. The server 10 includes a processing unit 110, a storage unit 130, and an interface unit 150. The processing unit 110 is connected to the storage unit 130 and the interface unit 150. The storage unit 130 stores at least one financial data, and each financial data includes a plurality of established contents if a plurality of items. Herein, the items may be various items of items such as an institution, a card type, settlement currency, a payment date (a payment date and the number of days), days of grace (days of grace and the number of days), a default date (a default date and the number of days), a debit date, a release status, the nationality, a linked institution, linked currency, a carrying method, a multi-currency card label, decimal digits, a cycle of a valid bill, the number of days for an authorization proportion, a condition for authorization comparison, a tolerance for authorization comparison, a tolerance for authorization cancellation, a credit limit control manner, a valid period of points, interest calculation after a debt is transformed to collection, interest calculation after a debt is transformed to a bad debt, the final payment of the collection, an age of the bad debt, the minimum payment of the bad debt, an age of the collection, transforming an accounting exchange rate, a control code for forcibly ceasing the debt, a control code for transforming an accounting account, a control code for deactivating the whole account, maintenance personnel, and a maintenance time. Herein, each financial data includes an established content of at least one item that is unchangeable and includes an established content of at least one item that is changeable.

A user may directly operate the server 10 to look up or edit each financial data or operate an electronic device 20 to communicably connect to the server 10 (as shown in FIG. 2) through a network 30 and look up or edit each financial data. In other words, the user may operate the server 10 or electronic device to generate a read signal, so as to read a financial data (hereinafter referred to as selected financial data). In some embodiments, the electronic device 20 may be a notebook computer, a smart phone, a tablet computer (Tablet or Pad), a desktop computer, or the like.

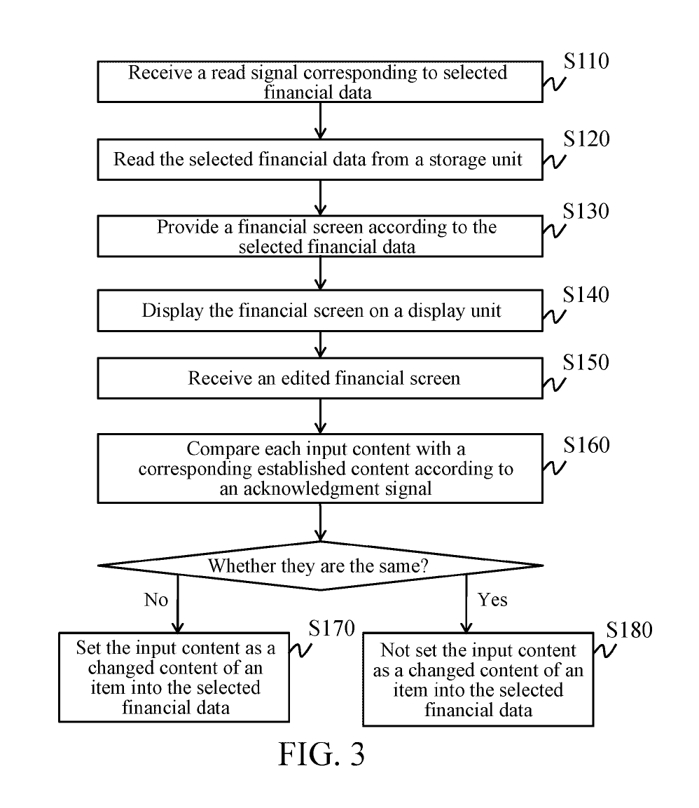

FIG. 3 is a flowchart of a method for managing changed financial data according to a first embodiment of the present invention.

In some embodiments, referring to FIG. 3, when the processing unit 110 of the server 10 receives the read signal corresponding to the selected financial data (step S110), the processing unit 110 reads the selected financial data from the storage unit 130 in response to the read signal (step S120) and provides the selected financial data read to the interface unit 150 (step S130). In an embodiment, when the read signal is generated by a user interface of the server 10, the interface unit 150 may be a display unit, and the processing unit 110 provides the selected financial data read to a display unit (the interface unit 150) and displays it on the display unit (the interface unit 150). In another embodiment, when the read signal is generated by an external device (a user interface communicably connected to the electronic device 20 of the server 10) of the server 10, the interface unit 150 may be a communications unit, the processing unit 110 provides the selected financial data read to the electronic device 20 through a communications unit (the interface unit 150), so as to display the selected financial data on a display unit of the electronic device 20.

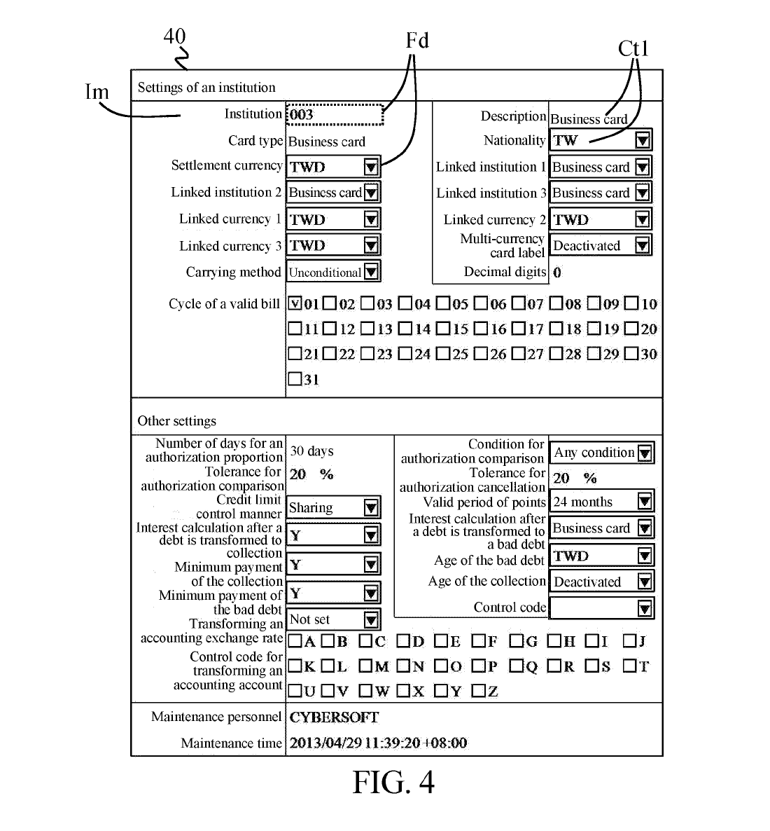

FIG. 4 is a schematic diagram of a financial screen according to a first example.

In some embodiments, referring to FIG. 3 and FIG. 4, the processing unit 110 provides the selected financial data by using a financial screen 40 (step S130). The financial screen 40 includes multiple items Im (a reference sign) and corresponding fields Fd. Established contents Ct1 of some or all items Im in the elected financial data are represented in fields Fd of the corresponding items. In an embodiment, when an established content Ct1 of a specific item Im is unchangeable, a field Fd of the item Im on the financial screen 40 may have no field border or have an unapparent field border. On the contrary, when an established content Ct1 of a specific item Im is changeable, a corresponding field Fd on the financial screen 40 may have no apparent field border. In some embodiments, the financial screen 40 may a scrollbar-style page.

For example, when the read signal is generated by the user interface of the server 10, the processing unit 110 provides a financial screen 40 with each field Fd represented by a corresponding established content Ct1 to the interface unit 150, so as to display the financial screen 40 on the display unit (interface unit 150) of the server 10 (step S140), for a user to view or perform editing by operating the user interface of the server 10. In addition, when the read signal is generated by an external electronic device 20 of the server 10, the processing unit 110 provides a financial screen 40 with each field Fd represented by a corresponding established content Ct1 to the interface unit 150 and transmits it to the external electronic device 20 by using the interface unit 150, so as to enable the electronic device 20 to display the received financial screen 40 on the display unit of the electronic device 20 (step S140), for a user to view or perform editing by operating the user interface of the electronic device 20.

When the user operates the user interface to edit any editable field Fd (namely, a field Fd representing a changeable established content), the user interface generates an edit signal corresponding to the field Fd. In other words, each edit signal indicates changing the established content Ct1 represented by the corresponding field Fd to an input content, so as to form an edited financial screen 40. When the user completes editing and performs storage of the edited financial screen 40, the user interface generates an acknowledgment signal. The processing unit 110 receives the edited financial screen 40 (step S150) and compares the input content of each field Fd with the original established content according to the acknowledgment signal (step S160). In other words, the processing unit 110 compares a content (namely, an input content) represented in each editable field Fd in the edited financial screen 40 with a content originally represented in the editable field Fd (that is, an established content of an item the same as that of the field Fd in the selected financial data), to determine whether the two are the same.

When the input content is different from the corresponding established content Ct1, the processing unit 110 sets the input content as a changed content of the item Im into the selected financial data (step S170). In other words, the processing unit 110 updates the selected financial data stored in the storage unit 130 to add a changed content Ct2 (the input content) of the item Im. After the update, the selected financial data stored in the storage unit 130 further includes a changed content of at least one item Im in addition to established contents Ct1 of a plurality of items Im. In some embodiments, when the processing unit 110 adds the changed content Ct2, a generation time (namely, a maintenance time) of the changed content Ct2 and an execution account (namely, the maintenance personnel) of this change would be stored associatively at the same time.

On the contrary, when the input content is the same as the corresponding established content Ct1, the processing unit 110 does not set the input content as a changed content of the item Im into the selected financial data (step S180). In other words, the processing unit 110 does not update the selected financial data stored in the storage unit 130 to maintain data contents of the selected financial data before the reading.

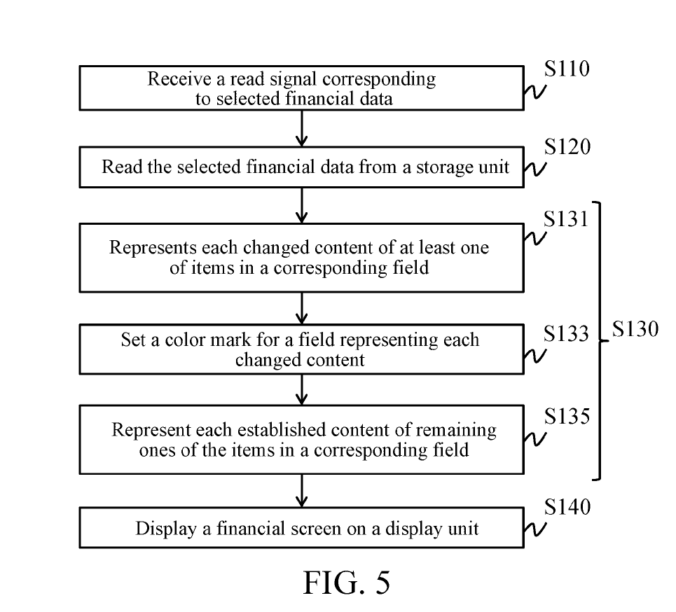

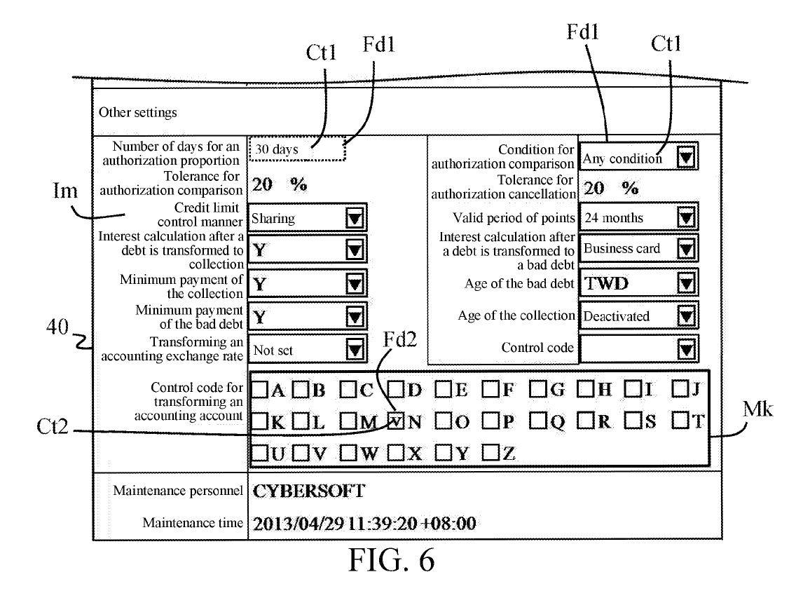

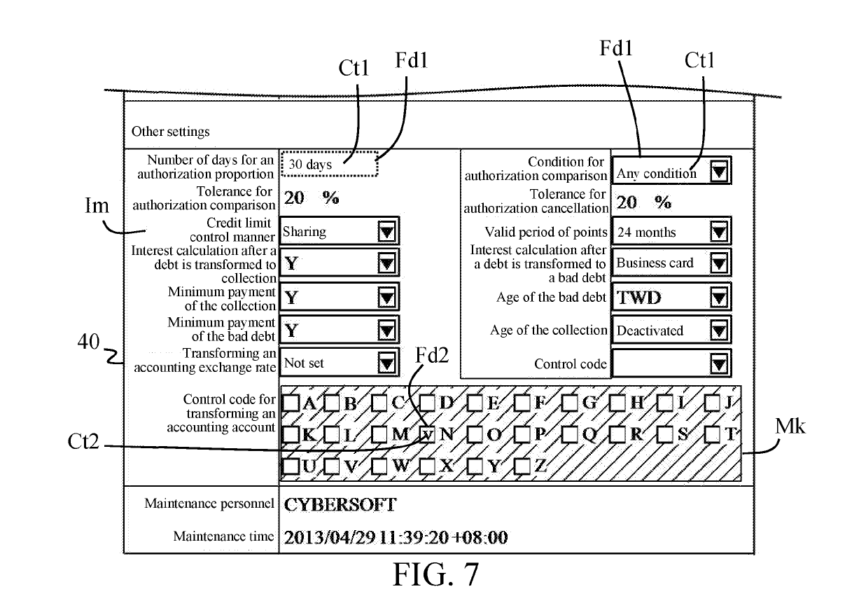

FIG. 5 is a flowchart of a method for managing changed financial data according to a second embodiment of the present invention. FIG. 6 is a partial schematic diagram of a financial screen according to a second example. FIG. 7 is a partial schematic diagram of a financial screen according to a third example.

In some embodiments, referring to FIG. 5 to FIG. 7, when the processing unit 110 of the server 10 receives the read signal corresponding to the selected financial data again (step S110), the processing unit 110 reads the selected financial data from the storage unit 130 in response to the read signal (step S120) and provides a financial screen 40 with the selected financial data read to the interface unit 150 (step S130). Thus, the selected financial data includes established contents Ct1 of a plurality of items Im and a changed content Ct2 of at least one item Im. In other words, at least one item Im has an established content Ct1 and a changed content Ct2 at the same time, and remaining items Im only have established contents Ct1.

In an embodiment of step S130, the processing unit 110 represents a changed content Ct2 in a corresponding field Fd2 on the financial screen 40 (step S131), and sets a color mark Mk for the field Fd2 that represents each changed content Ct2 (step S133), as shown in FIG. 6 and FIG. 7. In other words, when the item Im has an established content Ct1 and a changed content Ct2 at the same time, the processing unit 110 may choose to represent the changed content Ct2 of the item Im in a field Fd2 of the same item Im on the financial screen 40 and sets a color mark Mk for the field Fd2. On the contrary, when the item Im only has an established content Ct1, the processing unit 110 directly represents the established content Ct1 of the item Im in a field Fd1 of the same item Im on the financial screen 40 and does not set a color mark Mk for the field Fd1.

Moreover, the processing unit 110 would represent established contents Ct1 of remaining items Im (some or all) in corresponding fields Fd1 on the financial screen 40 (step S135). In other words, when the item Im only has an established content Ct1, the processing unit 110 directly represents the established content Ct1 of the item Im in a field Fd1 of the same item Im on the financial screen 40.

In some embodiments, the color mark Mk is a background that has a given color or a border that has the given color and that circles the field Fd2 of the changed content Ct2. In some embodiments, the given color is different from a background color of the financial screen 40. The given color may also be different from font colors representing the established content Ct1 and the changed content Ct2. In some embodiments, the given color may also be different from a background color of a field Fd1 representing each established content Ct1. For example, the background color of the financial screen 40 may be white, and the given color may be yellow or red. The given color may be a bright color.

Therefore, the financial screen 40 displayed on the display unit, in addition to representing an established content Ct1 or a changed content Ct2 of each item, presents a color mark Mk on the field Fd2 representing the changed content Ct2. Hence, the changed content represented on the financial screen 40 can be apparently displayed by using the color mark Mk, so as to enable a user that performs lookup to rapidly view the changed content represented on the financial screen 40 and thus, even make a review.

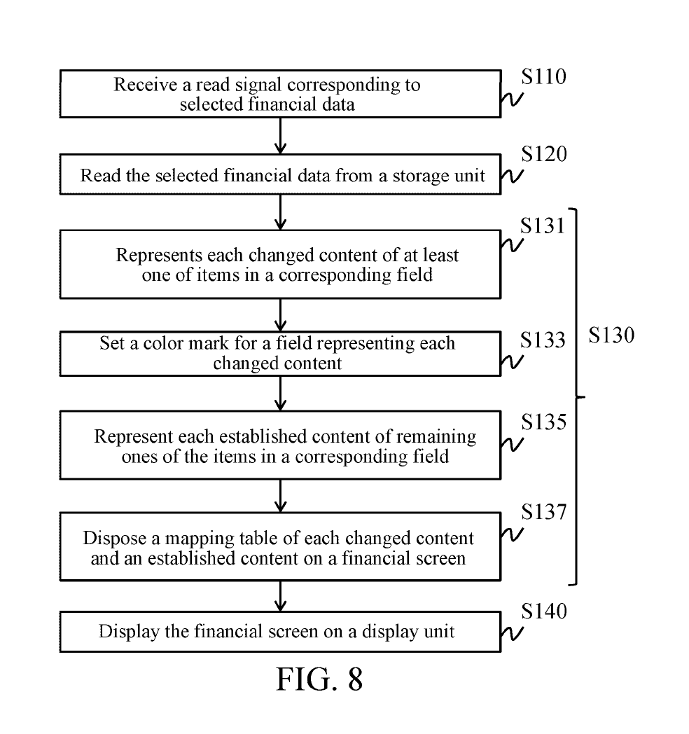

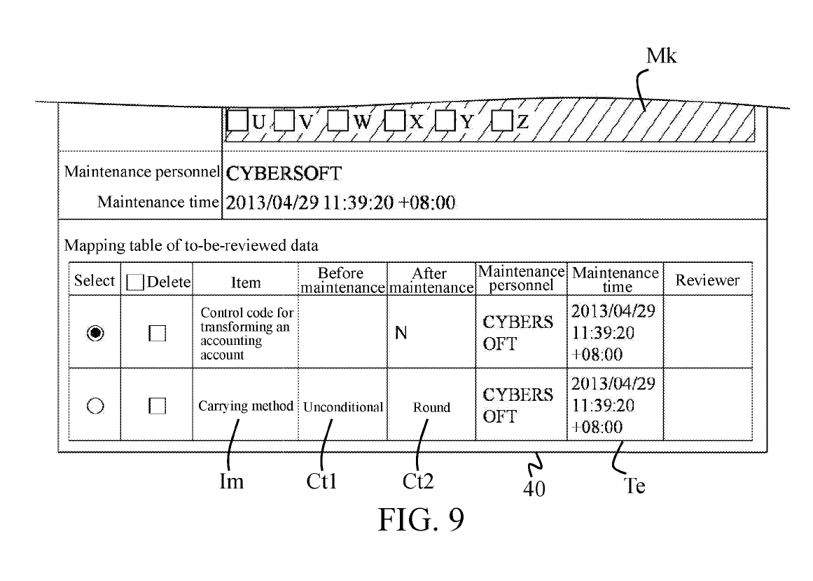

FIG. 8 is a flowchart of a method for managing changed financial data according to a third embodiment of the present invention. FIG. 9 is a partial schematic diagram of a financial screen according to a fourth example.

In some embodiments, referring to FIG. 8 and FIG. 9, the processing unit 110 may also dispose a mapping table Te of each changed content Ct2 and an established content Ct1 on the financial screen 40 (step S137).

In some embodiments, the processing unit 110 may, after reading the selected financial data, generate a mapping table Te according to each changed content Ct2, an established content Ct1 corresponding to each changed content Ct2, and information related to generation of each changed content Ct2 (such as maintenance personnel, a maintenance time, review personnel, or a combination thereof) in the selected financial data read.

In some embodiments, the processing unit 110 may, when updating the selected financial data with each changed content Ct2, generate a mapping table Te of a changed content Ct2 and an established content Ct1 in advance according to each changed content Ct2, an established content Ct1 corresponding to each changed content Ct2, and information related to generation of each changed content Ct2 (such as maintenance personnel, a maintenance time, review personnel, or a combination thereof) and updates the selected financial data with the generated mapping table Te (that is, storing the mapping table Te in the storage unit 130). In other words, after the update, the selected financial data stored in the storage unit 130 further includes a changed content and a mapping table Te of at least one item Im in addition to established contents Ct1 of a plurality of items Im. Therefore, in step S137, the processing unit 110 directly obtains the mapping table Te of the changed content Ct2 and the established content Ct1 from the selected financial data read and disposes on the mapping table Te on the financial screen 40.

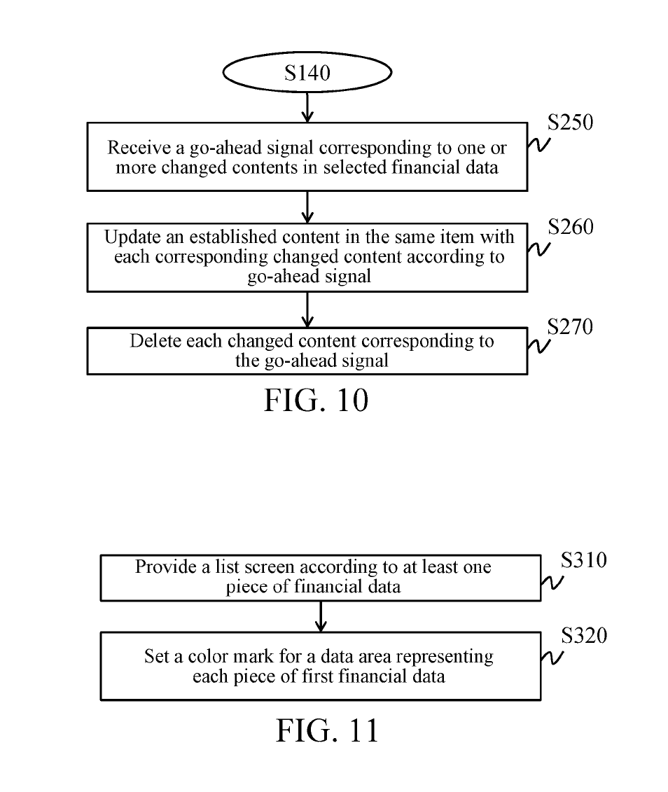

FIG. 10 is a flowchart of a method for managing changed financial data according to a fourth embodiment of the present invention.

In some embodiments, referring to FIG. 10, after the financial screen 40 is displayed, a user that makes a review (for example, a reviewer) can operate the user interface to acknowledge release of the selected financial data having a changed content Ct2. When the user acknowledges that a specific changed content Ct2 (one or more changed contents Ct2 in the selected financial data) or the selected financial data (all changed contents Ct2) is executable, the user interface correspondingly generates a go-ahead signal. The processing unit 110 receives a go-ahead signal corresponding to the specific changed content Ct2 or selected financial data (step S250) and updates an established content Ct1 of the same item Im with each changed content Ct2 corresponding to the go-ahead signal (step S260). In other words, the processing unit 110 replaces the established content Ct1 of the same item Im in the selected financial data with the changed content Ct2 in the selected financial data, that is, storing the changed content Ct2 as the established content Ct1 in the selected financial data into the storage unit 130. After the update, the processing unit 110 deletes each changed content Ct2 corresponding to the go-ahead signal from the selected financial data (step S270), that is, deleting each changed content Ct2 corresponding to the go-ahead signal from the storage unit 130. Then, the processing unit 110 provides a financial service for the user on the basis of the established content Ct1 of the updated selected financial data (the established content Ct1 replaced by the changed content Ct2).

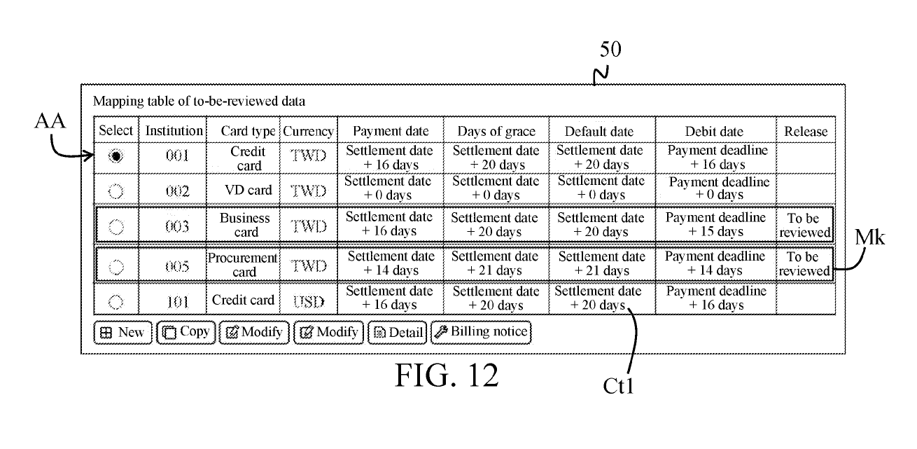

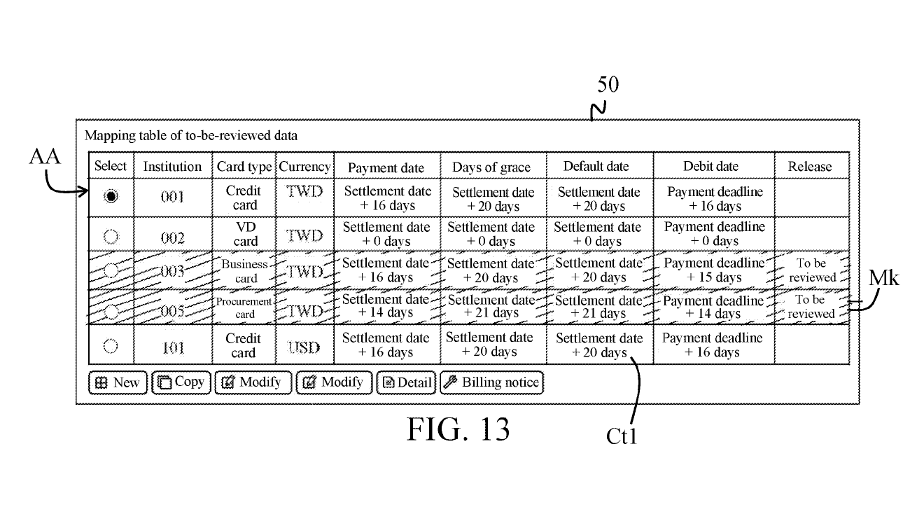

FIG. 11 is a flowchart of a method for managing changed financial data according to a fifth embodiment of the present invention. FIG. 12 is a schematic diagram of a list screen according to the first example. FIG. 13 is a schematic diagram of a list screen according to the second example.

In some embodiments, the server 10 provides each financial data for a user to look up or edit by means of a financial platform or an application program executing the method for managing changed financial data. Referring to FIG. 11 to FIG. 13, the user may operate a user interface (inputting an account and a password) to log in to a financial platform or an application program, so as to look up or edit each financial data. Herein, the processing unit 110 receives the account and password from the user interface and performs authentication on the account and password. After the authentication succeeds (the account is valid and the password is correct), the processing unit 110 executes the financial platform or application program to provide a list screen 50 according to at least one financial data (step S310). Referring to FIGS. 12 and 13, the list screen 50 includes at least one data area AA, and the at least one data area AA separately represents an excerpted content of the at least one financial data. That is, one data area AA represents an excerpted content of a financial data.

In some embodiments, the processing unit 110 reads one or more pieces of financial data from the storage unit 130 and obtains an established content Ct1 of a designated item Im from established contents Ct1 of each financial data read as an excerpted content. Then, the processing unit 110 represents the obtained excerpted content in the corresponding data area AA, provides the list screen 50 including an excerpted content of each financial data to the interface unit 150, and further displays the list screen 50 on the display unit for a user to view.

When there is one or more pieces of financial data (hereinafter referred to as first financial data) having a changed content Ct2 in the financial data read, the processing unit 110 also sets a color mark Mk for the data area AA representing each first financial data on the list screen 50, as shown in FIG. 12 and FIG. 13. In other words, with regard to that the financial data read includes one or more pieces of financial data (hereinafter referred to as second financial data) not having any changed content Ct2, the processing unit 110 does not a color mark Mk for the data area AA representing each second financial data on the list screen 50.

In some embodiments, the color mark Mk is a background that has a given color or a border that has the given color and that circles the data area AA representing the first financial data. In some embodiments, the given color is different from a background color of the list screen 50. The given color may also be different from font colors representing the excerpted content (namely, the established content Ct1) and the item Im (the reference sign). In some embodiments, the given color is different from a background color of a data area AA representing each excerpted content or different from a background color of a data area AA representing the excerpted content of the second financial data. For example, the background color of the list screen 50 may be white, and the given color may be yellow or red. The given color may be a bright color.

Therefore, the list screen 50 displayed on the display unit, in addition to representing an excerpted data of the financial data, presents a color mark Mk on the data area AA representing the excerpted content of the first financial data. Hence, the first financial data represented on the list screen 50 can be apparently displayed by using the color mark Mk, so as to enable a user that performs lookup to rapidly view the financial data having a changed content and thus, select any financial data to open a list of details of the financial data to view and/or review the financial data. For example, when a user selects any financial data to view a list of details by operating a user interface, the user interface generates a read signal corresponding to the financial data, so as to enable the processing unit 110 to read the corresponding financial data and provide the financial screen 40 according to the financial data read. It should be noted that although the steps are described in sequence in the preceding text, this sequence is not a limitation to the present invention. Persons skilled in the art should understand that in a proper situation, execution sequences of some steps may be the same or exchanged.

In some embodiments, the processing unit 110 may be implemented by one or more processing components. Herein, each processing component may be a microprocessor, a micro-controller, a digital signal processor, a microcomputer, a central processing unit, a field programmable gate array, a programmable logic device, a stator, a logic circuit, an analog circuit, a digital circuit and/or any apparatus operating signals (analog and/or digital) based on an operation command, which is not limited herein.

In some embodiments, the storage unit may be implemented by one or more storage components. Hence, the storage component may be, for example, a memory or a buffer, which is not limited herein.

In some embodiments, the display unit may be a display panel or screen. Moreover, the user interface may be a touch control module, which constitutes, together with the display panel, a touch screen, a combination of multiple physical keys, or a combination of a touch control module and one or more physical keys.

In conclusion, a method for managing changed financial data and a computer program product according to the present invention are applicable to providing a financial data-related screen for a user to view and/or review and setting a color mark for a corresponding content of financial data having a changed content, so that the corresponding content of the financial data having the changed content on the screen is apparently displayed, so as to enable the user to rapidly view the changed content and even make a review, thereby accelerating the review on the financial data.

What is claimed is:

1. A method for managing changed financial data, comprising:
reading a financial data from a storage unit, wherein the financial data comprises a plurality of established contents of a plurality of items and a changed content of at least one of the items; and
providing a financial screen according to the established contents and the at least one changed content, wherein the financial screen comprises a plurality of fields of the items, and the providing step comprises:
representing each of the changed contents in the corresponding field;
representing each of the established contents of remaining ones of the items in the corresponding field; and
setting a color mark for the field that represents each of the changed contents.

2. The method for managing changed financial data according to claim 1, wherein the color mark is a background that has a given color or a border that has the given color and that circles the field.

3. The method for managing changed financial data according to claim 2, wherein the given color is different from a background color of the financial screen.

4. The method for managing changed financial data according to claim 2, wherein the given color is different from a background color of the field of each of the established contents.

5. The method for managing changed financial data according to claim 1, wherein the providing step further comprises:
disposing a mapping table of the changed content and the corresponding established content on the financial screen.

6. The method for managing changed financial data according to claim 1, further comprising:
after the providing step, displaying the financial screen on a display unit.

7. The method for managing changed financial data according to claim 6, further comprising:
receiving a go-ahead signal corresponding to at least one of the at least one changed content;
using, according to the go-ahead signal, each of the changed contents corresponding to the go-ahead signal to update the established content of the same item; and
deleting each of the changed contents corresponding to the go-ahead signal.

8. The method for managing changed financial data according to claim 1, further comprising:
receiving a go-ahead signal corresponding to at least one of the at least one changed content;
using, according to the go-ahead signal, each of the changed contents corresponding to the go-ahead signal to update the established content of the same item; and
deleting each of the changed contents corresponding to the go-ahead signal.

9. A method for managing changed financial data, comprising:
providing a financial screen according to a financial data to perform editing, wherein the financial data comprises a plurality of established contents of a plurality of items, the financial screen comprises a plurality of fields of the items, and each of the established contents is represented in the corresponding field;
receiving the edited financial screen, wherein the established content represented by at least one of the fields in the edited financial screen is changed to an input content;
comparing each of the input contents with the corresponding established content according to an acknowledgment signal;
when the input content is different from the corresponding established content, setting the input content as a changed content of the item into the financial data; and
when the input content is different from the corresponding established content, not setting the input content as the changed content of the item into the financial data.

10. The method for managing changed financial data according to claim 9, wherein when the input content is different from the corresponding established content, the method further comprises:
forming a mapping table of each of the changed contents and the corresponding established content.

11. A method for managing changed financial data, comprising:
providing a list screen according to at least one financial data, wherein the list screen comprises at least one data area, the at least one data area separately represents an excerpted content of the at least one financial data, the at least one financial data comprises at least one first financial data, and each the first financial data comprises at least one changed content; and
setting a color mark for the data area that represents each the first financial data.

12. The method for managing changed financial data according to claim 11, wherein the color mark is a background that has a given color or a border that has the given color and that circles the data area.

13. The method for managing changed financial data according to claim 12, wherein the given color is different from a background color of the list screen.

14. The method for managing changed financial data according to claim 12, wherein the at least one financial data further comprises at least one second financial data, each the second financial data does not comprise any changed content, and the given color is different from a background color of the data area that represents each of the second financial data.

15. A computer program product, comprising a plurality of program codes, wherein the method for managing changed financial data according to claim 1 can be implemented after a computer loads and executes the plurality of program codes.
